(19) United States
(12) Patent Application Publication
(10) Pub. No.: US 2026/0232120 A1
(43) Pub. Date: Aug. 13, 2026

(54) DISPOSABLE FOOD CONTAINER

(71) Applicant: GPCP IP HOLDINGS LLC, Atlanta, GA (US)

(72) Inventors: Alexandra N. FILIATRAUT, Appleton, WI (US); Mark B. LITTLEJOHN, Grand Chute, WI (US); Jesse M. KRUEGER, Fox Crossing, WI (US)

(21) Appl. No.: 19/463,972

(22) Filed: Jan. 29, 2026

Related U.S. Application Data
(60) Provisional application No. 63/757,065, filed on Feb. 11, 2025.

(51) Int. Cl. A47G 19/03; B31B 50/59; B31B 110/20

(52) U.S. Cl. CPC A47G 19/03; B31B 50/59; B31B 2110/20

(57) ABSTRACT

Embodiments provide a pressware paperboard container formed from a blank that maximizes a food contact area of the plate with a relatively narrow rim while maintaining rigidity to support contents of the plate. The container including: pressformed from a generally planar paperboard blank including: a circular bottom portion extending to diameter D1; an inclined sidewall portion; a rim portion elevated from a lowest portion of the circular bottom portion by a height; and a downturn flange portion extending from the rim portion to an outer edge of the disposable food container, where a ratio of the diameter D1 of the circular bottom portion to a diameter D4 of the outer edge of the disposable food container is greater than 0.68, and where a ratio of the height to the diameter D4 of the outer edge of the disposable food container is greater than 0.10.

### CROSS-REFERENCE TO RELATED APPLICATIONS

This application claims priority to U.S. Provisional Application Ser. No. 63/757,065, filed on Feb. 11, 2025, the contents of which are hereby incorporated by reference in their entirety.

### TECHNOLOGICAL FIELD

Embodiments generally relate to disposable food containers pressformed from a generally planar paperboard blank, and more particularly, to pressware paperboard plates formed from a blank that maximize a food contact area of the plate through having a relatively tall sidewall relative to the plate diameter and a rim profile including a downturn flange that improves rigidity within a relatively narrow rim space.

### BACKGROUND

Disposable paper food containers are widely used throughout the food service industry from cook outs to fast food service restaurants to school cafeterias. Disposable paper food containers, such as plates, trays and bowls, are generally made by way of pulp-molding processes or by pressing a planar paperboard blank in a matched metal heated die set. The paperboard is conventionally produced by a wet laid paper making process and is typically available in the form of a continuous web on a roll. In a typical forming operation, the web of paperboard stock is fed continuously from a roll through a cutting die to form the circular blanks which are then fed into position between the upper and lower die halves.

Disposable food containers are generally configured to include a bottom portion and a rim. The rigidity of such disposable food containers are generally attributed to the strength and thickness of the material with which the container is made along with a rim profile surrounding the container. The thickness and strength of material used is generally directly related to a cost of the material, with thicker and stronger materials generally being more expensive. The rim profile is obtained at the expense of food contact area of the container for holding food. Stronger rim profiles often occupy a greater proportion of the surface area of the container.

The industry is continually trying to produce larger pressware products made of paper that have suitable strength and rigidity and that are visually appealing to a consumer.

### SUMMARY

Embodiments of the present disclosure are directed to a disposable food container, and more particularly, to pressware paperboard plates having a tall sidewall relative to the plate diameter enabled by a rim profile that improves rigidity within a relatively narrow rim space. Embodiments include a disposable food container pressformed from a generally planar paperboard blank including: a circular bottom portion extending to diameter D1; an inclined sidewall portion extending at an angle up and away from the circular bottom portion; a rim portion elevated from a lowest portion of the circular bottom portion by a height; and a downturn flange portion extending from the rim portion to an outer edge of the disposable food container, where the rim portion is disposed between the inclined sidewall portion and the downturn flange portion, where a ratio of the diameter D1 of the circular bottom portion to a diameter D4 of the outer edge of the disposable food container is greater than 0.68, and where a ratio of the height to the diameter D4 of the outer edge of the disposable food container is greater than 0.10.

The disposable food container of some embodiments further includes a first annular transition portion between the circular bottom portion and the inclined sidewall portion, where the first annular transition portion has a radius R1 of about 0.50 inches. The disposable food container of some embodiments further includes a second annular transition portion between the inclined sidewall portion and the rim portion, where the second annular transition portion has a radius R2 of about 0.12 inches. According to some embodiments the second annular transition portion extends around the disposable food container at diameter D2, where a ratio of the diameter D2 to the diameter D4 of the outer edge of the disposable food container is greater than 0.85.

According to certain embodiments the second annular transition portion is elevated from the circular bottom portion at the diameter D1 by a second height of at least ⅛^{th} of the diameter D1 of the circular bottom portion. According to some embodiments the second annular transition portion is elevated from the circular bottom portion at the diameter D1 by a second height of about 0.75 inches. The disposable food container of some embodiments further includes a first annular transition portion having a first radius R1 between the circular bottom portion and the inclined sidewall portion; and a second annular transition portion having a second radius R2 between the inclined sidewall portion and the rim portion, where the ratio of radius R1 to radius R2 is greater than 4.0.

According to some embodiments the rim portion begins at a diameter D2, where the diameter D2 is at least 90% of the diameter D4 of the outer edge of the disposable food container. The disposable food container of an example embodiment includes a third annular transition portion having a radius R3 between the rim portion and the downturn flange portion, where the ratio of radius R1 to radius R3 is greater than 4.0. According to some embodiments the height is at least ⅛ of the diameter D1 of the circular bottom portion. The height in an example embodiment is about 0.88 inches.

The inclined sidewall portion of an example embodiment extends at the angle up and away from the circular bottom portion at an angle of between about 55° and 65° from the circular bottom portion. According to some embodiments a volume of the disposable food container between the circular bottom portion and the rim portion is X units cubed of a unit of measure, where the volume divided by a square unit of the unit of measure results in X units of the unit of measure, where a blank diameter of a flat blank from which the disposable food container is formed is Y units of the unit of measure, and where X divided by Y is greater than 3.0.

The circular bottom portion of some embodiments includes a crown, where a center of the circular bottom portion is elevated from the lowest portion of the circular bottom portion. The circular bottom portion of certain embodiments includes a crown, where a center of the circular bottom portion is elevated from the lowest portion of the circular bottom portion by a height of about 0.13 inches. The circular bottom portion of some embodiments includes a crown, where a center of the circular bottom portion is elevated from the lowest portion of the circular bottom portion, and where the crown defines a radius of about 35.45 inches. According to some embodiments the generally planar paperboard blank defines a diameter of D0 and a blank surface area of 3.14*(D0/2)², where the disposable food container defines usable surface area below and surrounded by the rim portion, where a ratio of the usable surface area to the blank surface area is about 0.80.

Embodiments provided herein include a disposable food container pressformed from a generally planar paperboard blank including: a circular bottom portion extending to diameter D1; an inclined sidewall portion extending at an angle up and away from the circular bottom portion with a first annular transition portion between the circular bottom portion and the inclined sidewall portion; a rim portion where a second annular transition portion is disposed between the inclined sidewall portion and the rim portion, where the rim portion extends between diameter D2 and diameter D3 of the disposable food container; and a downturn flange portion extending from the rim portion to an outer edge of the disposable food container having a diameter D4, where a ratio of the diameter D2 to the diameter D4 is greater than 0.85.

According to some embodiments the second annular transition portion has a radius R2, where the first annular transition portion has a radius R1 of about 0.50 inches. According to certain embodiments the radius R2 is about 0.12 inches. The second annular transition portion of some embodiments is elevated from the circular bottom portion at the diameter D1 by a height of at least ⅛^{th} of the diameter D1.

The rim portion of an example embodiment is elevated from the circular bottom portion at the diameter D1 by a height of about 0.88 inches. According to some embodiments the first annular transition portion has a radius R1, where the second annular transition portion has a radius R2, and where the ratio of the radius R1 to the radius R2 is greater than 4.0.

The disposable food container of some embodiments further includes a third annular transition portion having a radius R3 between the rim portion and the downturn flange portion, where the ratio of the radius R1 to the radius R3 is greater than 4.0. According to certain embodiments the rim portion is elevated to a height above the circular bottom portion at diameter D1, where the height is at least ⅛ of the diameter D1 of the circular bottom portion. According to some embodiments the second annular transition portion is elevated from the circular bottom portion at diameter D1 by a height of about 0.75 inches.

The inclined sidewall portion of an example embodiment extends at the angle up and away from the circular bottom portion at an angle of between about 55° and 65° from the circular bottom portion. According to certain embodiments the circular bottom portion comprises a crown, where a center of the circular bottom portion is elevated from the circular bottom portion at D1. According to certain embodiments the circular bottom portion comprises a crown, where a center of the circular bottom portion is elevated from the circular bottom portion at D1 by a height of about 0.13 inches. The circular bottom portion of some embodiments includes a crown, where a center of the circular bottom portion is elevated from the circular bottom portion at D1, and where the crown defines a radius of about 35.45 inches. According to an example embodiment the generally planar paperboard blank defines a diameter of D0 and a blank surface area of 3.14*(D0/2)², where the disposable food container defines usable surface area below and surrounded by the rim portion, where a ratio of the usable surface area to the blank surface area is about 0.80.

Embodiments provided herein include method of pressforming a disposable food container from a generally planar paperboard blank including: inserting a generally planar paperboard blank having a diameter D0 into a pressform; pressforming the disposable food container to include: a circular bottom portion extending to a diameter D1; an inclined sidewall portion extending at an angle up and away from the circular bottom portion; a rim portion elevated from a lowest portion of the circular bottom portion by a height; and a downturn flange portion extending from the rim portion to an outer edge of the disposable food container of diameter D4, where a ratio of the diameter D4 to the diameter D0 is greater than 0.85, and where a ratio of the height to the diameter D4 is greater than 0.10.

According to some embodiments the circular bottom portion extends to diameter D1, where a ratio of the diameter D1 to the diameter D4 is greater than 0.68. The method of some embodiments further includes pressforming the disposable food container to further include: a first annular transition portion having a radius R1 between the circular bottom portion and the inclined sidewall portion, a second annular transition portion having a radius R2 between the inclined sidewall portion and the rim portion, where a ratio of radius R1 to radius R2 is greater than 4.0.

The method of some embodiments optionally includes pressforming the disposable food container to further include: a third annular transition portion having a radius R3 between the rim portion and the downturn flange portion, where a ratio of radius R1 to radius R3 is greater than 4.0. According to some embodiments the radius R1 is about 0.50 inches. According to certain embodiments the rim portion extends around the disposable food container beginning at diameter D2, where a ratio of the diameter D2 to the diameter D4 of the outer edge of the disposable food container is greater than 0.85. The height of an example embodiment is about 0.88 inches.

According to some embodiments the circular bottom portion includes a crown, where a center of the circular bottom portion is elevated from the circular bottom portion at D1. According to certain embodiments the circular bottom portion comprises a crown, where a center of the circular bottom portion is elevated from the circular bottom portion at D1 by a height of about 0.13 inches. The circular bottom portion of certain embodiments includes a crown, where a center of the circular bottom portion is elevated from the circular bottom portion at D1, and where the crown defines a radius of about 35.45 inches. The generally planar paperboard blank of an example embodiment defines a diameter of D0 and a blank surface area of 3.14*(D0/2)², where the disposable food container defines usable surface area below and surrounded by the rim portion, where a ratio of the usable surface area to the blank surface area is about 0.80.

Embodiments provided herein include a disposable food container pressformed from a generally planar paperboard blank including: a bottom portion extending to a characteristic diameter D1; an inclined sidewall portion extending at an angle up and away from the bottom portion; a rim portion elevated from a lowest portion of the bottom portion by a height; and a downturn flange portion extending from the rim portion to an outer edge of the disposable food container, where the rim portion is disposed between the inclined sidewall portion and the downturn flange portion, where a ratio of the characteristic diameter D1 of the bottom portion to a characteristic diameter D4 of the outer edge of the disposable food container is greater than 0.68, and where a ratio of the height to the characteristic diameter D4 of the outer edge of the disposable food container is greater than 0.10.

The disposable food container of some embodiments further includes a first annular transition portion between the bottom portion and the inclined sidewall portion, where the first annular transition portion has a characteristic radius R1 of about 0.50 inches. The disposable food container of some embodiments further includes a second annular transition portion between the inclined sidewall portion and the rim portion, where the second annular transition portion has a characteristic radius R2 of about 0.12 inches. According to some embodiments the second annular transition portion extends around the disposable food container at characteristic diameter D2, where a ratio of the characteristic diameter D2 to the characteristic diameter D4 of the outer edge of the disposable food container is greater than 0.85.

According to certain embodiments the second annular transition portion is elevated from the bottom portion at the characteristic diameter D1 by a second height of at least ⅛th of the characteristic diameter D1 of the bottom portion. The second annular transition portion of some embodiments is elevated from the bottom portion at the characteristic diameter D1 by a second height of about 0.75 inches.

The disposable food container of some embodiments further includes: a first annular transition portion having a characteristic radius R1 between the bottom portion and the inclined sidewall portion; and a second annular transition portion having a characteristic radius R2 between the inclined sidewall portion and the rim portion, where the ratio of the characteristic radius R1 to the characteristic radius R2 is greater than 4.0. According to some embodiments the rim portion begins at a characteristic diameter D2, where the characteristic diameter D2 is at least 90% of the characteristic diameter D4 of the outer edge of the disposable food container.

The disposable food container of some embodiments further includes: a third annular transition portion having a characteristic radius R3 between the rim portion and the downturn flange portion, where the ratio of the characteristic radius R1 to the characteristic radius R3 is greater than 4.0. According to some embodiments the height is at least ⅛ of the characteristic diameter D1 of the bottom portion. According to certain embodiments the height is about 0.88 inches. The inclined sidewall portion of some embodiments extends at the angle up and away from the bottom portion at an angle of between about 55° and 65° from the bottom portion.

According to some embodiments a volume of the disposable food container between the bottom portion and the rim portion is X units cubed of a unit of measure, where the volume divided by a square unit of the unit of measure results in X units of the unit of measure, where a blank diameter of a flat blank from which the disposable food container is formed is Y units of the unit of measure, and where X divided by Y is greater than 3.0.

The bottom portion of an example embodiment includes a crown, where a center of the bottom portion is elevated from the lowest portion of the bottom portion. According to some embodiments the bottom portion comprises a crown, where a center of the bottom portion is elevated from the lowest portion of the bottom portion by a height of about 0.13 inches. According to certain embodiments the generally planar paperboard blank defines a characteristic diameter of D0 and a blank surface area, where the disposable food container defines usable surface area below and surrounded by the rim portion, where a ratio of the usable surface area to the blank surface area is about 0.80.

Embodiments provided herein include a method of pressforming a disposable food container from a generally planar paperboard blank including: inserting a generally planar paperboard blank having a characteristic diameter D0 into a pressform; pressforming the disposable food container to include: a bottom portion extending to a characteristic diameter D1; an inclined sidewall portion extending at an angle up and away from the bottom portion; a rim portion elevated from a lowest portion of the bottom portion by a height; and a downturn flange portion extending from the rim portion to an outer edge of the disposable food container of characteristic diameter D4, where a ratio of the characteristic diameter D4 to the characteristic diameter D0 is greater than 0.85, and where a ratio of the height to the characteristic diameter D4 is greater than 0.10.

According to some embodiments the bottom portion extends to characteristic diameter D1, where a ratio of the characteristic diameter D1 to the characteristic diameter D4 is greater than 0.68. The method of some embodiments further includes pressforming the disposable food container to further include: a first annular transition portion having a characteristic radius R1 between the bottom portion and the inclined sidewall portion, a second annular transition portion having a characteristic radius R2 between the inclined sidewall portion and the rim portion, where a ratio of the characteristic radius R1 to the characteristic radius R2 is greater than 4.0.

The method of some embodiments further includes pressforming the disposable food container to further include: a third annular transition portion having a characteristic radius R3 between the rim portion and the downturn flange portion, where a ratio of the characteristic radius R1 to the characteristic radius R3 is greater than 4.0. According to some embodiments the characteristic radius R1 is about 0.50 inches. The rim portion of an example embodiment extends around the disposable food container beginning at characteristic diameter D2, where a ratio of the characteristic diameter D2 to the characteristic diameter D4 of the outer edge of the disposable food container is greater than 0.85.

According to some embodiments the height is about 0.88 inches. According to certain embodiments the bottom portion comprises a crown, where a center of the bottom portion is elevated from the bottom portion at the characteristic diameter D1. According to an example embodiment the bottom portion comprises a crown, where a center of the bottom portion is elevated from the bottom portion at the characteristic diameter D1 by a height of about 0.13 inches. The bottom portion of an example embodiment includes a crown, where a center of the bottom portion is elevated from the bottom portion at the characteristic diameter D1, and where the crown defines a radius of about 35.45 inches. The generally planar paperboard blank of an example embodiment defines a characteristic diameter D0 and a blank surface area, where the disposable food container defines usable surface area below and surrounded by the rim portion, where a ratio of the usable surface area to the blank surface area is about 0.80.

Embodiments provided herein include a disposable food container pressformed from a generally planar paperboard blank including: a bottom portion extending to characteristic diameter D1; an inclined sidewall portion extending at an angle up and away from the bottom portion with a first annular transition portion between the bottom portion and the inclined sidewall portion; a rim portion where a second annular transition portion is disposed between the inclined sidewall portion and the rim portion, where the rim portion extends between characteristic diameter D2 and characteristic diameter D3 of the disposable food container; and a downturn flange portion extending from the rim portion to an outer edge of the disposable food container having a characteristic diameter D4, where a ratio of the characteristic diameter D2 to the characteristic diameter D4 is greater than 0.85.

Various other aspects are also described in the following detailed description and in the attached claims.

### BRIEF DESCRIPTION OF THE DRAWINGS

Having thus described embodiments of the disclosure in general terms, reference will now be made to the accompanying drawings, which are not necessarily drawn to scale, and wherein:

FIG. 1 illustrates a perspective view of a disposable food container according to an example embodiment of the present disclosure;

FIG. 2 illustrates a top view of a disposable food container according to an example embodiment of the present disclosure;

FIG. 3 illustrates a section view of a disposable food container according to an example embodiment of the present disclosure;

FIG. 4 illustrates a detail section view of a disposable food container according to an example embodiment of the present disclosure;

FIG. 5 illustrates another detail section view of a disposable food container according to an example embodiment of the present disclosure;

FIG. 6 illustrates a table of bottom-side dimensions formed by a die-side of the forming die for disposable food containers according to an example embodiment of the present disclosure; and

FIG. 7 illustrates a diagram of an apparatus for determining rim stiffness according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention can be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative,” “exemplary,” and the like are used to be examples with no indication of quality level. Like reference numerals refer to like elements throughout. Thus, use of any such terms should not be taken to limit the spirit and scope of embodiments of the present invention.

Disposable food containers configured in accordance with the present disclosure generally include a generally planar bottom portion, a relatively steep, generally straight sidewall portion as well as a rim portion and a downturn flange portion at an outer edge of the container. This profile has been found to be particularly suitable for disposable containers such as plates, platters, bowls and the like because it combines improved physical properties while maximizing the usable space or “food contact area” in a relatively small blank size. The food contact area, as described herein, includes the area within the container that food is contained as detailed further below. Embodiments described herein enable a larger food contact area than previously available from a similarly sized blank through incorporation of the steep side wall angle which provides strength, the narrow rim which increases food contact area, and the downturn flange which further provides strength. The annular transition portions between these elements further enhance the strength while complementing the relatively large food contact area. Disposable food containers are made from a variety of materials in a wide variety of shapes and sizes. To be able to compare such containers, standardized rigidity tests have been developed such that the robustness of any given combination of materials and design can be evaluated and assessed as described further below.

Embodiments described herein provide a disposable pressboard container that has enhanced product rigidity per material utilization, a relatively deep usable area, and a relatively narrow rim to achieve these advantages. Embodiments described herein are particularly well suited to applications where additional strength is required including buffets or parties where heavier food loads are more likely. Such products include for example, oval platters, deep dish, and containers.

The containers of the present disclosure as will be seen from the rigidity and rim stiffness data discussed below and the dimensions, generally exhibit the desirable features of achieving both significant rigidity relative to the material thickness/strength and an increased usable surface or food contact area in a single product. That is to say, containers manufactured in accordance with the present disclosure generally exhibit rigidity generally not possible in products having both comparable materials and comparable food contact area for a similarly sized blank. Containers of the present disclosure thus combine desirable features of radically different disposable container designs. The plates of the present disclosure may be manufactured using existing paperboard blank diameters if so desired.

Without intending to be bound by any theory or specific geometry of the inventive containers, the generally linear, inclined profile of the sidewall and its location from the product center, the relatively small radii of annular transition portions on either side of a rim portion and a downturn flange in combination have beneficial effects on the overall rigidity of the product as related to food carrying capacity. The sidewall, rim, and downturn flange profile can be configured to provide enhanced local rim stiffness as well. In some cases it is desirable to optimize rim stiffness while in others, one may wish to maximize rigidity measures for standardized rigidity tests. For example, one may wish to maximize rim stiffness for lower caliper products of adequate overall rigidity, whereas for a higher caliper product with more than adequate rim stiffness, one may wish to maximize overall rigidity.

Typical disposable plates are sold in packaging showing their relative nominal sizes. Diameters are given for plates in inches and capacity in fluid ounces for bowls. Actual product diameters vary; for a nominal 9 inch plate, the actual diameter is typically 8.38 inches to 9.25 inches. Actual product diameters for nominal 10 inch plates are typically 10 to 10.5 inches. It is desirable to have product diameters reasonably close to competitive products for each nominal size. A product that is substantially smaller in diameter and selling for a comparable price may not be perceived to have the same value even though the bottom food container area for example, and product height may be parity or better. In any event, it will be seen from the various product designs possible within the spirit and scope of the present disclosure that the product diameter may be adjusted by changing, for example, the product height or an optional transition portion length to achieve the desired characteristics.

While example embodiments illustrated herein relate to a generally circular disposable food container, embodiments may have various other shapes that benefit from the structural arrangements of the container described herein. Disposable containers of the present disclosure generally have a characteristic diameter and corresponding characteristic radius. For circular bowls, plates, platters and the like, the characteristic diameter is simply the outer diameter of the product. For other shapes, an average diameter can be used; for example, the arithmetic average of the major and minor axes could be used for elliptical shapes, whereas the average length of the sides of a rectangular shape is used as the characteristic diameter and so forth. A disposable food container in the form of a plate has a characteristic diameter which simply corresponds to the diameter of the plate since the plate is generally circular. The dimensions and dimensional ratios described herein reference radii and diameters; however, one of ordinary skill in the art would appreciate that these radii and diameters can be interpreted as the characteristic radii and diameters of non-circular disposable food containers. Similarly, transitional portions of the disposable food container described herein as annular are generally ring shaped, though rather than strictly circular in shape, the annular transition portions encircle portions of the disposable food container such that they need not be circular. Thus, whether the disposable food container includes oval, rectangular, or other shape, an annular transition portion is around or encircling at least a portion of the disposable food container, such as the first annular transition portion described below encircles the bottom portion regardless of shape.

The products of the embodiments described herein may be made from any suitable material for example plastic, paper, paperboard, and like materials. Typically paperboard is a material of choice and the manufacturing process consists of hot pressing the plates in a heated die set as is well known in the art. Plates so formed may be made utilizing paperboard calipers anywhere from about 10 mils to about 25 mils (163 pound/3000 sq. ft ream being a 14 mil caliper and a 206 pound/3000 sq. ft. ream being an 18.5 mil caliper paperboard.)

Embodiments described herein include a durable pressware paperboard product created from a 9.38″ diameter blank forming an approximately 8.38″ diameter plate at a relatively taller height compared to typical similarly sized plates which provides improved food containment over a conventional plate height which may be around 0.50 inches to 0.75 inches, for example. The unique shape illustrated and described herein provides users with a large food contact area pressware paperboard product while still using an 9.38″ diameter blank which reduces overall cost. The large height-to-diameter ratio of embodiments provide a unique container distinct from anything presently available. While there are multiple ways to achieve the described height-to-diameter ratio, embodiments include a non-obvious solution implemented to achieve a consistent 8.38″ diameter plate from a 9.38″ blank diameter. The profile described herein results in a large plate food contact area and large eating volume which approaches the volume of a large bowl shape, enabling users to use the disclosed embodiments for multiple meal occasions while remaining a relatively low-cost solution. The unique shape described herein is achieved in part by narrowing a flat portion of the product rim that extends into two small radii including one leading to a downturn flange as described below, thus allowing for a large product bottom and tall height which maximizes eating area while maintaining efficient material use.

Pressware paper plates, having been formed from blanks of around 9.38 inches, can vary in outer diameter. However, the food contact area of these plates is very important product attribute to the consumer since this space defines the carrying capacity of the plate. The sidewall to sidewall distance and overall plate heights are also important since they help contain the articles being carried during transport and consumption. Plates with great heights are highly desirable due to their containment advantages. Bowls and deep-dish pressware products can be formed from these same 9.38 inch blanks. However, their bottom surface diameters are typically greatly reduced and are typically used as bowls for soups, salads, etc.

Embodiments of the disposable food container described herein provides a plate with a greater height as desirable to consumers, while maintaining a bottom area and sidewall to sidewall distance similar to shallower plates. Embodiments described herein have a relatively high strength or rigidity as compared to comparable plates formed with the same paper basis weights/calipers.

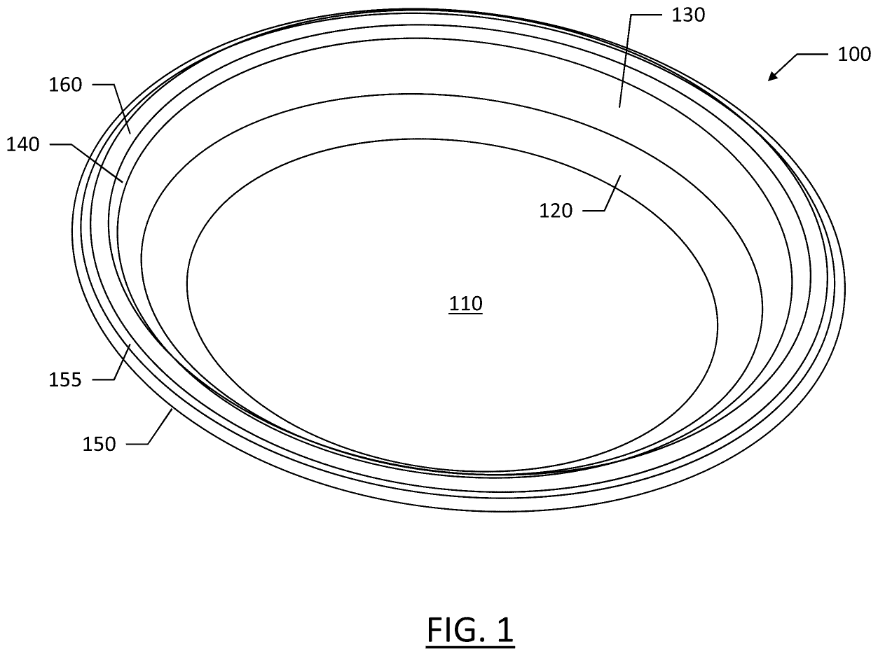

Referring now to FIGS. 1-3, embodiments of the present disclosure are illustrated in connection with several designs for disposable food container made from paperboard blanks and pressed in a heated die set as described hereinafter.

A disposable food container 100 in the form of a plate having a characteristic diameter from outer edge to an opposite (180 degree opposed) outer edge generally includes a bottom surface 110 which is a generally planar portion, a first annular transition portion 120, an inclined sidewall portion 130 as well as a second annular transition portion 140. The bottom surface 110 in some embodiments includes a crown or convex curvature that can improve strength as described below. The sidewall has a generally linear profile between the first annular transition portion 120 and the second annular transition portion 140. Generally speaking, the inclined profile defines an angle of inclination with respect to the horizontal bottom surface 110 of from about 55° to about 65°. This relatively steep sidewall portion provides a deep draw to the bottom surface thereby increasing a volume that can be comfortably carried on the disposable food container. The second annular transition portion 140 transitions from the inclined sidewall portion 130 to a rim portion 160. A third annular transition portion 155 transitions from the rim portion 160 to an outer downturn flange portion 150. The first annular transition portion has a radius R1, the second annular transition portion has a radius R2, and the third annular transition portion has a radius R3.

While the illustrated embodiment depicts an angle of inclination of the side wall to be between 55° and 65°, the angle of inclination of some embodiments can range from 45° to 55°, 65° to 75°, and even 75° to 85° and not deviate substantially from some of the advantages described herein. However, embodiments described herein including the stiffness measures described below preferably include an angle of inclination of the side wall of between 55° and 65°.

The usable surface area or food contact surface, as described herein, is defined from the maximum height of the container (e.g., rim portion 160) and below within the bounds of the container. Under this definition of the usable surface area or food contact surface, embodiments of the container described herein maximize the food contact surface while maintaining rigidity through the structural arrangement of the container. The surface area of the usable surface area includes the bottom surface 110, the first annular transition portion 120, the inclined side wall, and the second annular transition portion 140. The usable surface area is below and surrounded by the rim portion 160.

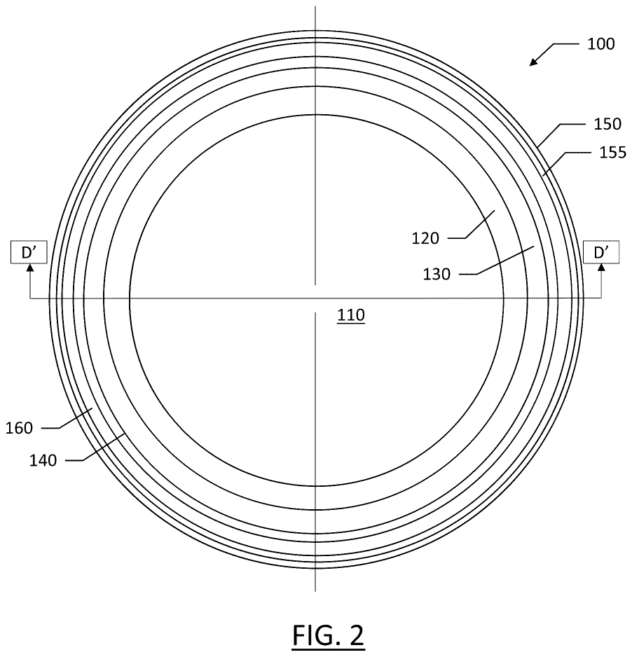

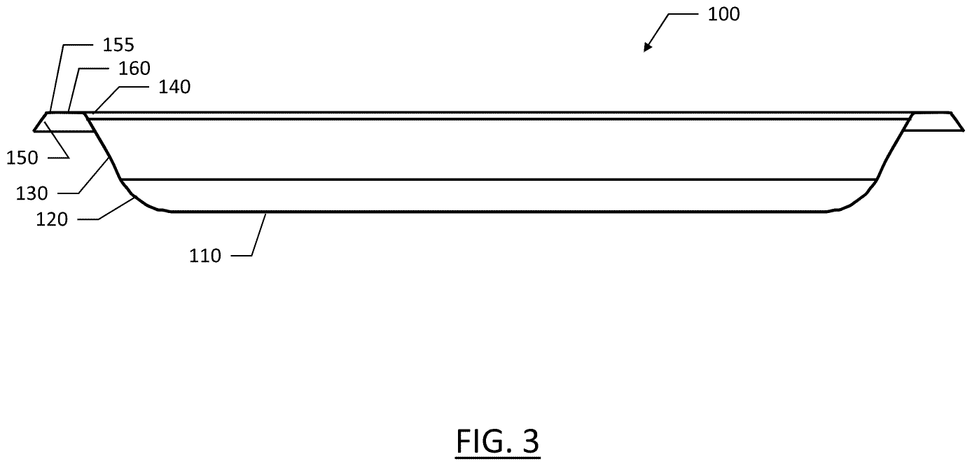

FIG. 2 illustrates a top view of the disposable food container 100 of FIG. 1 with section line D′-D′ through the diameter. Visible in FIG. 2 are the concentric annular transition portions of the first annular transition portion 120, the second annular transition portion 140, and the third annular transition portion 155. FIG. 3 illustrates the section view through section line D′-D′ of FIG. 2 better illustrating the rim portion 160, the third transition portion 155, and the downturn flange 150.

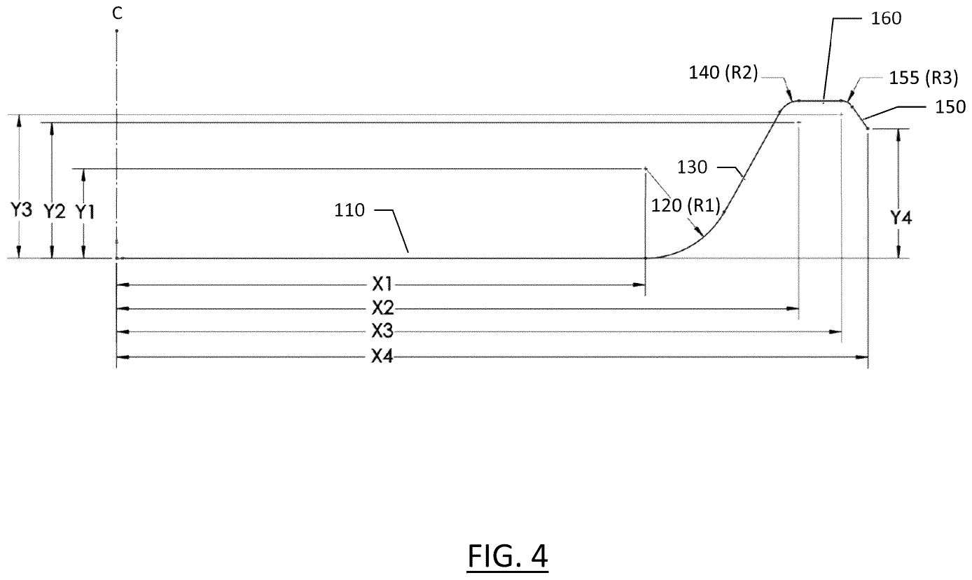

A portion of the section view D′-D′ is illustrated in FIG. 4 with labeled dimensions for one half of the disposable food container 100 shown from centerline C to the outer edge of the container at the edge of the downturn flange 150. Visible in the section view of FIG. 4 is the bottom surface 110, the first annular transition portion 120 (having radius R1), the inclined sidewall portion 130, the second annular transition portion 140 (having radius R2), the rim portion 160, the third annular transition portion 155 (having radius R3), and the downturn flange portion 150.

The blank diameter of example embodiments has a diameter D0 for reference. According to an example embodiment described herein beginning with a blank of 9.38 inches, the bottom surface 110 which is substantially planar in the illustrated embodiment has a radius X1 of around 2.94 inches, though this radius can range from about 2.88 inches to 3.13 inches. This radius extends to where the first annular transition portion 120 begins. The overall radius X4 of the disposable food container 100 formed from the 9.38 inch blank is about 4.19 inches forming an overall plate diameter (D4 or 2*X4) of around 8.38 inches from an outer edge of the downturn flange portion 150 to an opposite (180 degrees apart) downturn flange portion 150. The overall radius may vary from about 4.12 inches to about 4.25 inches.

While the bottom surface diameter D1 (e.g., 2*X1 shown in FIG. 4) is around six inches total, the volume that the plate of example embodiments can hold is increased substantially with the relatively tall, inclined sidewall portion 130. The height Y2 from the bottom surface 110 to the second annular transition portion 140 is around 0.75 inches, and the height to the rim portion 160 is around 0.88 inches (e.g., Y2+R2). This height at the start of the rim portion 160 is achieved at a radius X2 of around 3.79 inches from the centerline (diameter D2 of 2*X2 or 7.57), which results in a volumetric capacity of the plate of about 30-32 cubic inches. This is achieved while maintaining a high degree of rigidity in the plate to help support the volume of contents that the plate can carry through the unique design of the rim and downturn flange profile.

The first annular transition portion 120 between the bottom surface 110 and the inclined sidewall portion 130 has a radius R1 of about 0.50 inches. This radius, together with the inclined angle of the sidewall of around 55° to 65° degrees contributes substantially to the volume the plate can carry as the diameter of the plate as it reaches the second annular transition portion 140 increases by around 1.70 inches (e.g., between 2*X1 and 2*X2).

The inclined sidewall portion 130 transitions to the generally flat rim portion 160 at the second annular transition portion 140 having a radius R2 of around 0.12 inches, which is much more sharp than radius R1 as the volumetric increase is realized based on the larger radius R1, where the sharper radius R2 forms a top of the volume of the disposable food container 100 and therefore benefits from a quicker transition to the rim portion 160. A ratio of radius R1 of the first annular transition portion 120 to radius R2 of the second annular transition portion 140 may be in excess of 4.0. The width of the rim portion 160 (e.g., the delta between X2 and X3 in FIG. 4) is around 0.24 inches. The flat surface of the rim portion 160 is intentionally narrow as the space is not usable space of the plate and widening the rim portion 160 would take away from material available for the food contact surface. However, narrowing of the rim portion generally results in lower rigidity. Embodiments described herein overcome the narrowing of the rim portion 160 through the unique configuration of the inclined side wall, the rim portion, and the downturn flange, along with the transition portions between these elements.

The bottom surface 110 which is generally circular in the illustrated embodiment and includes diameter D1 (e.g., 2*X1 in FIG. 4) transitions to the inclined side wall 130 through annular transition portion 120 having radius R1. The inclined side wall 130 extends upwardly at an angle of between about 55° and 65°, to the second transition portion 140 having radius R2. The rim portion 160 extends from the second transition portion 140 at diameter D2 (e.g., 2*X2) to the third transition portion 155 beginning at diameter D3 (e.g., 2*X3). The third transition portion having radius R3 transitions to the downturn flange 150, which extends to an outer diameter of the container D4 (e.g., 2*X4). The combination of the first transition portion 120, the inclined side wall 130, the second transition portion 140, the rim portion 160, the third transition portion 155, and the downturn flange 150 employing the dimensional ranges and ratios described herein trades off rim width to gain food contact area, while providing significant rigidity to support contents of the food contact area.

The rim portion 160 is bounded by two concentric (about the centerline C) bends in the profile of the plate to include radius R2 of the second annular transition portion 140 and a radius R3 which is formed at the third annular transition portion 155 where the mid rim portion 160 meets the downturn flange 150. The radius R3 is again a sharper radius of around 0.08 inches to form the downturn flange 150. The ratio of the radius R1 of the first annular transition portion 120 to the radius R3 of the third annular transition portion 155 may in excess of 4.0, and in some cases, as high as 10.0.

The narrowness of the rim portion 160 between the second annular transition portion 140 and the third annular transition portion 155 of the disposable food container 100 avoids consuming valuable space on the blank that would take away from food contact area but would generally sacrifice rigidity. User perception at the time of purchase is often focused on the user-perceived functionality of the usable space of the plate found between the centerline C and radius X2. The width between the second annular transition portion 140 and the outer edge of the plate (at X4) is around 0.38 inches. The ratio of the overall plate diameter (e.g., D4 or 2*X4) to the width between the second annular transition portion 140 and the edge of the plate (e.g., X4−X2) can exceed 20:1, which yields a very substantial portion of the plate area as usable space and increases user satisfaction with the container.

Based on the dimensions described above, in the formed plate having an overall diameter of 8.38 inches, the usable surface area is approximately 54.75 square inches while the surface area occupied between the second annular transition portion 140 at X2 and the edge of the outer annular flange portion 150 at X4 is only around 12.0 square inches. This results in a substantial proportion of the plate serving the primary purpose a user expects of a plate, while maintaining a sufficiently rigid plate that can support a substantial weight on the plate itself. Using a blank having diameter (e.g., D0) of 9.38 inches has a substantially planar surface area of about 69 square inches. A disposable food container formed as described herein including a usable surface area of 54.75 inches is around 80% of the total planar surface area of the blank.

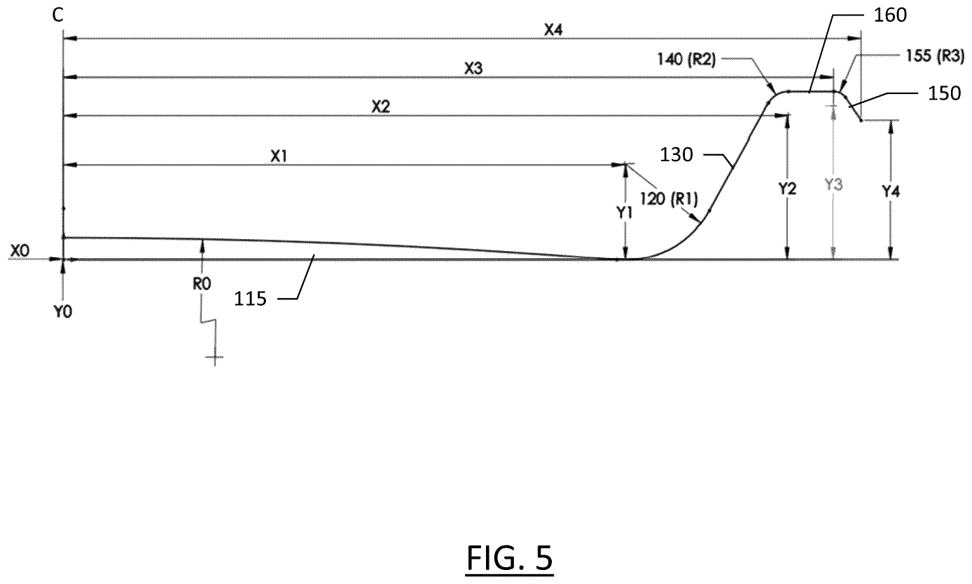

Embodiments of the disposable food container described herein can optionally be formed with a crown in the bottom surface. FIG. 5 illustrates such an example with the bottom surface 115 exhibiting the curvature of a crown. This can be imparted by the manufacturing process and the dies used to form the disposable food container. The crown of the bottom surface 115 can add strength and rigidity to the container as the crown is pre-stressed in a direction opposite that of the weight of food or other articles placed onto the bottom surface. As the crown of the bottom surface 115 begins to flatten, it pushes outwardly against the first annular transition portion 120 which, in combination with the remaining portion of the rim (e.g., inclined sidewall portion 130, second annular transition portion 140, mid rim portion 160, third annular transition portion 155, and annular flange portion 150) resists this outward push and thus the plate can generally carry more weight. The crown of the example embodiment of FIG. 5 may have a radius, such as about 35.45 inches, though this radius can be increased or decreased, such as by as much as 20%, while achieving similar benefits. The crown of the embodiment of FIG. 5 having a radius of about 35.45 would result in a center of the crown being elevated with respect to a lowest point of the bottom portion of about 0.13 inches.

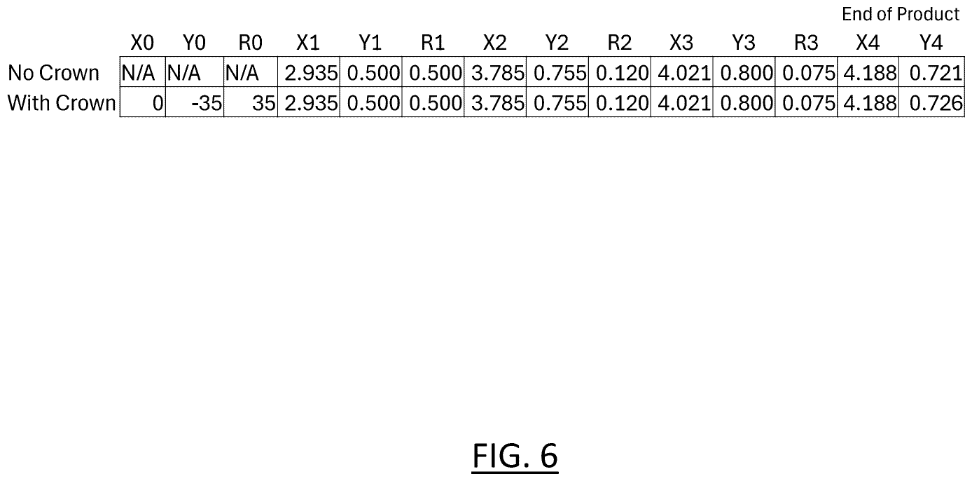

Dimensions appearing in the table of FIG. 6 for example embodiments are those that are measured from the centerline as illustrated in FIGS. 4 and 5 unless otherwise indicated. These dimensions are dimensions of a bottom-side of the food container formed by a die-side of a forming die. It should be appreciated that for many products such as pressed paperboard products or thermoformed plastic products, the dimensions of the product may vary slightly from the die dimensions due to relaxation after forming, for example, a radius of curvature of a portion of the container may increase after forming and the corresponding included angle may decrease slightly. Intra-product variances may exist due to, for example, off-center forming. In such cases, average or mean values are used to characterize the container.

The height to food container diameter ratio of embodiments described herein is greater than about 0.10 which is taller than most available pressed paper plates particularly using the same blank size. The overall height is around 0.88 inches using an 8.38 inch food container diameter which allows for improved food containment and to encourage users to use the product across different uses and occasions. The greater height and height to diameter ratio was developed with specific transition portion radii and specific angle orientations of the different surfaces to provide the strength and rigidity desired while providing an improved disposable food container with a wide range of uses. This unique structure enables the relatively larger food contact area and an increased container volume while compensating for a relatively narrow rim through the steep sidewall angle and the downturn flange to maintain rigidity necessary to carry food within the increased available space.

Disposable food containers of the type described herein are tested using standardized rigidity tests to be able to compare relative strengths among different products and different profiles. Tests include evaluation for Single Service Institute (SSI) or Foodservice Packaging Institute (FPI) rigidity, both of which are expressed in grams of force per 0.5 inches of deflection. The FPI Rigidity can be measured using a Food Service Packaging Institute Rigidity Tester, available from or through the Food Service Packaging Institute, 150 S. Washington Street, Suite 204, Falls Church, VA 22046. SSI rigidity is measured with the Single Service Institute Plate Rigidity Tester of the type originally available through Single Service Institute, 1025 Connecticut Ave., N.W., Washington, D.C. While these standardized tests are conducted to determine and compare relative strengths among different products, computer modeling and simulation is often used during development to simulate the relative strength without requiring prototypes to be physically formed.

Rim Stiffness is a measure of the local rim strength about the periphery of the container as opposed to overall or SSI rigidity. This test has been noted to correlate well with actual consumers' perception of product sturdiness. SSI rigidity is one measure of the load carrying capability of the plate, whereas Rim Stiffness often relates to what a consumer feels when flexing a plate to gauge its strength. Plates with higher Rim Stiffness have also demonstrated greatly improved weight carrying capabilities under simulated use testing. Preferably, specimens are conditioned and testing performed at standard conditions for paperboard testing when a paper container is tested, 72° F. and 50% relative humidity.

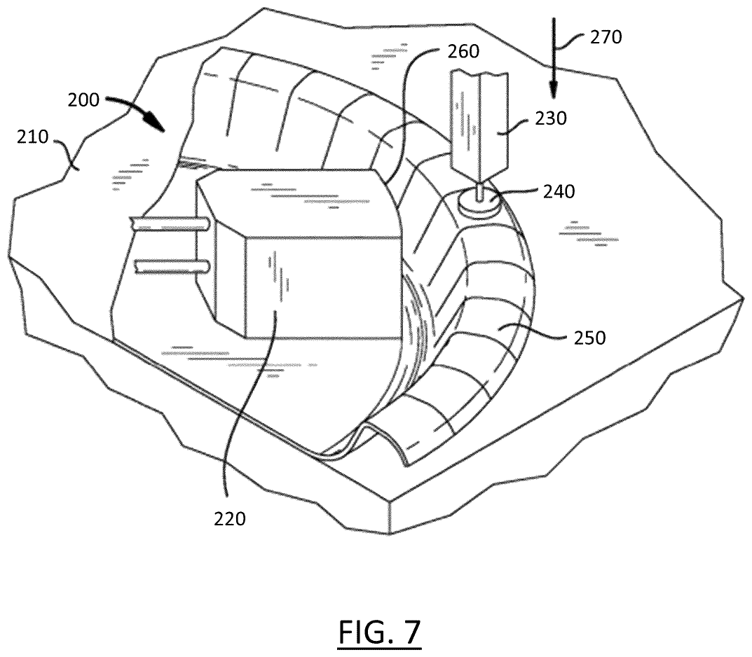

The particular apparatus employed is referred to as a Rim Stiffness instrument, developed by Georgia-Pacific Corporation, Neenah Technical Center, 1915 Marathon Avenue, Neenah, Wis. 54956. This instrument includes a micrometer which reads to 0.001 inch available from Standard Gage Co., Inc., 70 Parker Avenue, Poughkeepsie, N.Y. 12601, as well as a load gauge available from Chatillon, Force Measurements Division, P.O. Box 35668, Greensboro, N.C. 27425-5688. The test procedure measures the force to deflect the rim downwardly 0.1 inch as the specimen is restrained about its bottom between a platen and a restraining member as will be further appreciated by reference to FIG. 7.

Rim Stiffness instrument 200 includes generally a platen 210, a plurality of restraining members, preferably four equally spaced restraining members such as member 220 and a gauge 230 provided with a probe 240. A specimen such as plate 250 is positioned as shown and clamped tightly about its planar bottom portion to platen 210 by way of restraining members, such as member 220. The specimen is clamped over an area of several square inches or so such that the bottom of the specimen is fully restrained inwardly from the first transition portion. Note that restraining member 220 is disposed such that its outer edge 260 is positioned at the periphery of the serving area of the container, that is, at X1 in FIG. 4, the radius of the circular bottom of the container.

Probe 240 is then advanced downwardly in the direction of arrow 270 a distance of 0.1 inch while the force is measured and recorded by gauge 230. Only the maximum force is recorded, typically occurring at the maximum deflection of 0.1 inch. Probe 240 is preferably positioned in the center of the flange of plate 250 or on a high point of the flange as appropriate. The end of the probe may be disk-shaped or of other suitable shape and is preferably mounted on a universal-type joint so that contact with the rim is maintained during testing. Probe 240 is generally radially aligned with restraining clamp member 220.

In some examples, the FPI rigidity of the disposable food container described herein can be a low of about 60 grams to a high of about 170 grams as measured by the Foodservice Packaging Institute rigidity system standard expressed in grams of force per 0.5 inches of deflection using Folding Box Board (FBB) or economy board. Computer modeled FPI rigidity measures of 166 to 240 grams can be achieved even using 13 point caliper Solid Bleached Substrate (SBS) board of 155 pounds per 3,000 square feet. Thicker, stronger materials can be used to achieve higher FPI rigidity measures. In other examples, the FPI rigidity of the disposable food container can be a low of about 175 grams, about 200 grams, or about 250 grams to a high of about 275 grams, about 300 grams, or about 325 grams, as measured by the Foodservice Packaging Institute rigidity system standard expressed in grams of force per 0.5 inches of deflection.

A basis weight of the pressware paperboard blank in FBB can be a low of about 130 lbs/3,000 ft² to a high of about 160 lbs/3,000 ft². A basis weight of the pressware paperboard blank in SBS can be a low of about 145 lbs/3,000 ft² to a high of about 206 lbs/3,000 ft². A caliper of the pressware paperboard blank of FBB can be a low of about 11 mils to about 16 mils or using SBS a low of about 14 mils to about 18.5 mils

Embodiments described herein provide a disposable food container that can maintain a high degree of rigidity despite having a relatively large surface area and relatively narrow flange. The flange of example embodiments is of sufficient width to afford a user a surface to grasp and carry while being narrow enough to minimize a reduction in the usable surface area of the container.

While the embodiment above has been described in connection with a generally circular shaped example, it will be appreciated by one of skill in the art that plates, platters, trays and so forth having various shapes and sizes may be developed with the inventive characteristics described above. Some may be square or rectangular with rounded corners, triangular, multi-sided, polygonal and similar shape having the profile as described. The products may be compartmented. So also, instead of using a single paperboard layer blank, a composite paperboard blank may be used. For example, an embodiment of a container may be formed from a composite paperboard material wherein the containers are formed by laminating three separate paperboard layers to one another in the form of the container having any of the aforementioned shapes. Containers of the present disclosure thus provide for increases in Rigidity, Rim Stiffness, as well as an improved ability to support a load. Modifications to the specific embodiments described above, within the spirit and scope of the present invention as is set forth in the appended claims, will be readily apparent to those of skill in the art.

The embodiments described herein may be scalable to accommodate at least the aforementioned applications. Various components of embodiments described herein can be added, removed, modified, and/or duplicated as one skilled in the art would find convenient and/or necessary to implement a particular application in conjunction with the teachings of the present disclosure. In some embodiments, specialized features, characteristics, materials, components, and/or equipment may be applied in conjunction with the teachings of the present disclosure as one skilled in the art would find convenient and/or necessary to implement a particular application.

Moreover, many modifications and other embodiments of the present disclosure set forth herein will come to mind to one skilled in the art to which this disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

That which is claimed is:

1. A disposable food container pressformed from a generally planar paperboard blank comprising:
a circular bottom portion extending to diameter D1;
an inclined sidewall portion extending at an angle up and away from the circular bottom portion;
a rim portion elevated from a lowest portion of the circular bottom portion by a height; and
a downturn flange portion extending from the rim portion to an outer edge of the disposable food container, wherein the rim portion is disposed between the inclined sidewall portion and the downturn flange portion,
wherein a ratio of the diameter D1 of the circular bottom portion to a diameter D4 of the outer edge of the disposable food container is greater than 0.68, and
wherein a ratio of the height to the diameter D4 of the outer edge of the disposable food container is greater than 0.10.

2. The disposable food container of claim 1, further comprising a first annular transition portion between the circular bottom portion and the inclined sidewall portion, wherein the first annular transition portion has a radius R1 of about 0.50 inches.

3. The disposable food container of claim 2, further comprising a second annular transition portion between the inclined sidewall portion and the rim portion, wherein the second annular transition portion has a radius R2 of about 0.12 inches.

4. The disposable food container of claim 3, wherein the second annular transition portion extends around the disposable food container at diameter D2, wherein a ratio of the diameter D2 to the diameter D4 of the outer edge of the disposable food container is greater than 0.85.

5. The disposable food container of claim 4, wherein the second annular transition portion is elevated from the circular bottom portion at the diameter D1 by a second height of at least ⅛^{th} of the diameter D1 of the circular bottom portion.

6. The disposable food container of claim 4, wherein the second annular transition portion is elevated from the circular bottom portion at the diameter D1 by a second height of about 0.75 inches.

7. The disposable food container of claim 1, further comprising:
a first annular transition portion having a radius R1 between the circular bottom portion and the inclined sidewall portion; and
a second annular transition portion having a radius R2 between the inclined sidewall portion and the rim portion, wherein the ratio of the radius R1 to the radius R2 is greater than 4.0.

8. The disposable food container of claim 7, wherein the rim portion begins at a diameter D2, wherein the diameter D2 is at least 90% of the diameter D4 of the outer edge of the disposable food container.

9. The disposable food container of claim 7, further comprising:
a third annular transition portion having a radius R3 between the rim portion and the downturn flange portion, wherein the ratio of the radius R1 to the radius R3 is greater than 4.0.

10. The disposable food container of claim 1, wherein the height is at least ⅛ of the diameter D1 of the circular bottom portion.

11. The disposable food container of claim 1, wherein the height is about 0.88 inches.

12. The disposable food container of claim 1, wherein the inclined sidewall portion extends at the angle up and away from the circular bottom portion at an angle of between about 55° and 65° from the circular bottom portion.

13. The disposable food container of claim 1, wherein a volume of the disposable food container including the circular bottom portion and the rim portion is X units cubed of a unit of measure, wherein the volume divided by a square unit of the unit of measure results in X units of the unit of measure, wherein a blank diameter of a flat blank from which the disposable food container is formed is Y units of the unit of measure, and wherein X divided by Y is greater than 3.0.

14. The disposable food container of claim 1, wherein the circular bottom portion comprises a crown, wherein a center of the circular bottom portion is elevated from the lowest portion of the circular bottom portion.

15. The disposable food container of claim 1, wherein the circular bottom portion comprises a crown, wherein a center of the circular bottom portion is elevated from the lowest portion of the circular bottom portion by a height of about 0.13 inches.

16. The disposable food container of claim 1, wherein the circular bottom portion comprises a crown, wherein a center of the circular bottom portion is elevated from the lowest portion of the circular bottom portion, and wherein the crown defines a radius of about 35.45 inches.

17. The disposable food container of claim 1, wherein the generally planar paperboard blank defines a diameter D0 and a blank surface area of 3.14*(D0/2)², wherein the disposable food container defines usable surface area below and surrounded by the rim portion, wherein a ratio of the usable surface area to the blank surface area is about 0.80.

18. A method of pressforming a disposable food container from a generally planar paperboard blank comprising:
inserting a generally planar paperboard blank having a diameter D0 into a pressform;
pressforming the disposable food container to include:
a circular bottom portion extending to a diameter D1;
an inclined sidewall portion extending at an angle up and away from the circular bottom portion;
a rim portion elevated from a lowest portion of the circular bottom portion by a height; and
a downturn flange portion extending from the rim portion to an outer edge of the disposable food container of diameter D4,
wherein a ratio of the diameter D4 to the diameter D0 is greater than 0.85, and
wherein a ratio of the height to the diameter D4 is greater than 0.10.

19. The method of claim 18, wherein the circular bottom portion extends to diameter D1, wherein a ratio of the diameter D1 to the diameter D4 is greater than 0.68.

20. A disposable food container pressformed from a generally planar paperboard blank comprising:
a bottom portion extending to a characteristic diameter D1;
an inclined sidewall portion extending at an angle up and away from the bottom portion;
a rim portion elevated from a lowest portion of the bottom portion by a height; and
a downturn flange portion extending from the rim portion to an outer edge of the disposable food container, wherein the rim portion is disposed between the inclined sidewall portion and the downturn flange portion,
wherein a ratio of the characteristic diameter D1 of the bottom portion to a characteristic diameter D4 of the outer edge of the disposable food container is greater than 0.68, and
wherein a ratio of the height to the characteristic diameter D4 of the outer edge of the disposable food container is greater than 0.10.
